(19) United States
(12) Patent Application Publication
(10) Pub. No.: US 2024/0397029 A1
(43) Pub. Date: Nov. 28, 2024

(54) INFORMATION PROCESSING APPARATUS AND INFORMATION PROCESSING METHOD

(71) Applicant: Sony Group Corporation, Tokyo (JP)

(72) Inventor: Yoshiaki KOUYAMA, Kanagawa (JP)

(73) Assignee: Sony Group Corporation, Tokyo (JP)

(21) Appl. No.: 18/689,872

(22) PCT Filed: Feb. 17, 2022
(86) PCT No.: PCT/JP2022/006344

§ 371 Date: Mar. 7, 2024

(30) Foreign Application Priority Data
Sep. 21, 2021 (JP) 2021-153530

(51) Int. Cl. H04N 13/327; G06V 10/60; H04N 13/305; H04N 13/31

(52) U.S. Cl. CPC H04N 13/327; G06V 10/60; H04N 13/305; H04N 13/31

(57) ABSTRACT

A measurement device (10; 10A; 10B) (corresponding to an example of “an information processing apparatus”) includes: a captured image acquisition unit (12a) that acquires the captured image of a stereoscopic display (5) including a light distribution member (5c) disposed on a display unit (5b) that distributes light beams of an image displayed on the display unit (5b) to allow a stereoscopic object to be visually recognized; a capturing position acquisition unit (12b) that acquires the capturing position at the time of acquisition of the captured image; and a calculation unit (12c) or a display control unit (12d) (corresponding to an example of a “correction information output unit”) that outputs correction information for the stereoscopic display (5) for correcting display unevenness of the stereoscopic display (5) based on the change in the phase pattern which is included in the captured image and generated according to the capturing position, and the capturing position.

### FIELD

The present disclosure relates to an information processing apparatus and an information processing method.

### BACKGROUND

Conventionally, there is known a stereoscopic display that imparts directivity to light beams emitted from pixels by a light distribution member such as a lenticular lens or a parallax barrier disposed on a display device such as a liquid crystal panel and provides a viewer with a stereoscopic display by a parallax image.

In such a stereoscopic display, in order to perform accurate display with respect to the viewpoint of the viewer, it is necessary to accurately control the light beam direction by the light distribution member. Therefore, a technique for obtaining optical parameters of a stereoscopic display for performing such control is proposed.

For example, in the technique disclosed in Patent Literature 1, two different reference images are displayed on the display device, and the relative inclination angle and cycle of the light distribution member with respect to the display device are uniquely obtained as optical parameters from the difference between the cycle and the inclination angle of interference fringes observed by the reference images.

### CITATION LIST

### Patent Literature

Patent Literature 1: JP 2014-066539 A

### SUMMARY

### Technical Problem

However, the related art described above has room for further improvement in contributing to resolving image quality degradation in stereoscopic display. For example, in the light distribution member, unevenness may occur in the plane due to deviation at the time of manufacturing or deviation caused by thermal or mechanical stress at the time of use, and an error may occur in a desired light beam direction.

In such a case, since distortion occurs in the cycle and the inclination angle of the interference fringes, there is a problem that the optical parameters cannot be accurately measured in the related art described above. In addition, since the pattern analysis of the interference fringes is required to calculate the optical parameters, it is required to secure a display area of a pattern sufficient for the analysis, and there is also a problem that the local parameters cannot be calculated. Therefore, when stereoscopic display is performed by using the parameter, image quality degradation such as display unevenness may occur.

Therefore, the present disclosure proposes an information processing apparatus and an information processing method that can contribute to resolving image quality degradation in stereoscopic display.

### Solution to Problem

In order to solve the above problems, one aspect of an information processing apparatus according to the present disclosure includes: a captured image acquisition unit that acquires the captured image of a stereoscopic display including a light distribution member disposed on a display unit that distributes light beams of an image displayed on the display unit to allow a stereoscopic object to be visually recognized; a capturing position acquisition unit that acquires the capturing position at the time of acquisition of the captured image; and a correction information output unit that outputs correction information for the stereoscopic display for correcting display unevenness of the stereoscopic display based on the change in the phase pattern which is included in the captured image and generated according to the capturing position, and the capturing position.

### BRIEF DESCRIPTION OF DRAWINGS

FIG. 1 is a diagram showing directivities of light beams by a lenticular lens system and a parallax barrier system.

FIG. 2 is a diagram illustrating an example of a pixel array.

FIG. 3 is a diagram (part 1) illustrating a design value of a light distribution member.

FIG. 4 is a diagram (part 2) illustrating the design value of the light distribution member.

FIG. 5 is a diagram illustrating a state of display unevenness.

FIG. 6 is a diagram illustrating repetition of viewpoints by the light distribution member.

FIG. 7 is a diagram illustrating distribution of viewpoints by the light distribution member.

FIG. 8 is a diagram illustrating a difference in observation luminance at different observation positions.

FIG. 9 is a diagram illustrating a phase shift of the light distribution member from a reference position.

FIG. 10 is a diagram (part 1) illustrating a method of calculating a phase shift amount.

FIG. 11 is a diagram (part 2) illustrating the method of calculating the phase shift amount.

FIG. 12 is a diagram illustrating a difference in a phase difference due to a thickness error.

FIG. 13 is a diagram illustrating a phase difference caused by a thickness error.

FIG. 14 is a block diagram illustrating a configuration example of a measurement device according to a first embodiment of the present disclosure.

FIG. 15 is a block diagram illustrating a configuration example of a measurement device according to a second embodiment of the present disclosure.

FIG. 16 is a block diagram illustrating a configuration example of a measurement device according to a third embodiment of the present disclosure.

FIG. 17 is a supplementary explanatory view of the measurement device according to each embodiment.

FIG. 18 is a block diagram illustrating a configuration example of a video output device according to the first embodiment of the present disclosure.

FIG. 19 is a block diagram illustrating a configuration example of a video output device according to the second embodiment of the present disclosure.

FIG. 20 is a block diagram illustrating a configuration example of a video output device according to the third embodiment of the present disclosure.

FIG. 21 is an explanatory diagram (part 1) of a correction information output unit.

FIG. 22 is an explanatory diagram (part 2) of the correction information output unit.

FIG. 23 is a hardware configuration diagram illustrating an example of a computer that realizes functions of the measurement device.

### DESCRIPTION OF EMBODIMENTS

Hereinafter, embodiments of the present disclosure are described in detail based on the accompanying drawings. In each of the following embodiments, the same parts are denoted by the same reference numerals, and redundant description is omitted.

In addition, hereinafter, in a stereoscopic display, an image display portion in which pixels such as a liquid crystal panel are arranged is appropriately referred to as a “display unit”.

In addition, the present disclosure is described according to the following item order.
1. Information Processing Method According to First Embodiment
2. Information Processing Method According to Second Embodiment
3. Information Processing Method According to Third Embodiment
4. Information Processing Apparatus Using Information Processing Method According to Embodiments
4-1. Configuration of Measurement Device According to First Embodiment
4-2. Configuration of Measurement Device According to Second Embodiment
4-3. Configuration of Measurement Device According to Third Embodiment
4-4. Supplement for Measurement Device According to Embodiments
4-5. Configuration of Video Output Device According to First Embodiment
4-6. Configuration of Video Output Device According to Second Embodiment
4-7. Configuration of Video Output Device According to Third Embodiment
4-8. Correction Information Output Unit
5. Modifications
6. Hardware Configuration
7. Conclusion

### 1. Information Processing Method According to First Embodiment

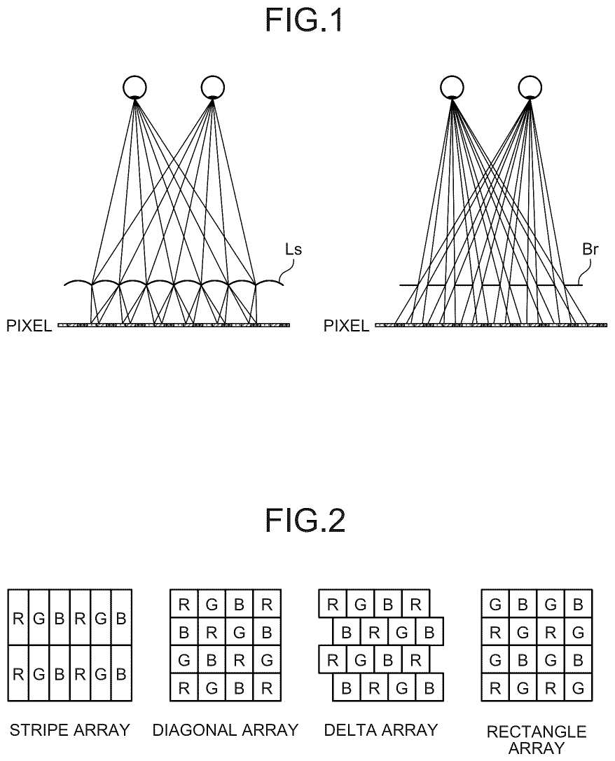

First, an information processing method according to a first embodiment of the present disclosure is described with reference to FIGS. 1 to 7. FIG. 1 is a diagram showing directivities of light beams by a lenticular lens system and a parallax barrier system. Also, FIG. 2 is a diagram illustrating an example of a pixel array.

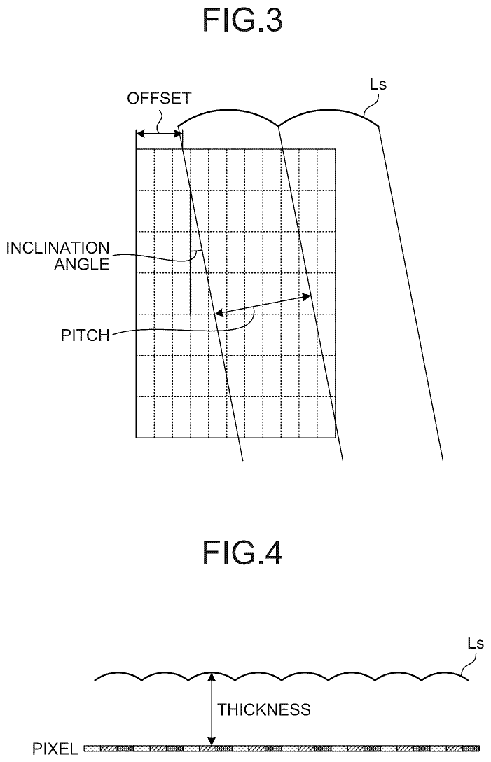

Also, FIG. 3 is a diagram (part 1) illustrating a design value of a light distribution member. Also, FIG. 4 is a diagram (part 2) illustrating the design value of the light distribution member. Note that FIG. 3 illustrates a positional relationship in a case where the display unit is viewed from the front, and FIG. 4 illustrates a positional relationship in a case where the display unit is viewed from the cross section.

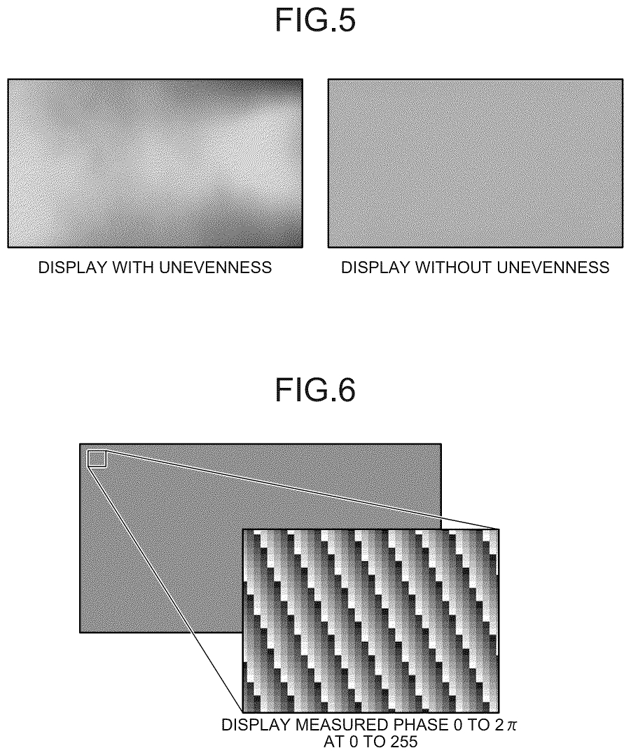

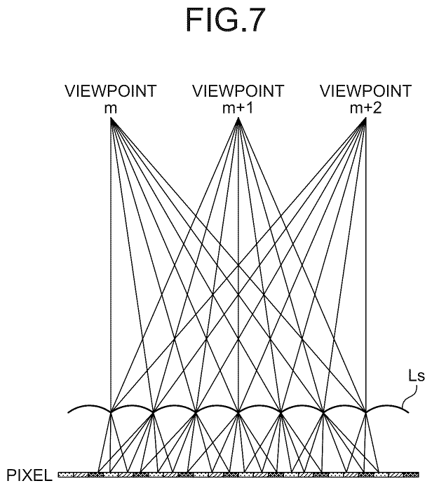

Also, FIG. 5 is a diagram illustrating a state of display unevenness. Also, FIG. 6 is a diagram illustrating repetition of viewpoints by the light distribution member. Also, FIG. 7 is a diagram illustrating distribution of viewpoints by the light distribution member.

The information processing method according to the first embodiment of the present disclosure is a method in which, in a stereoscopic display in which a light distribution member is arranged on a display unit and directivities are imparted to light beams emitted from a pixel of the display unit by the light distribution member, a fringe image is displayed on the display unit with shifting phases, luminance information of an interference fringe observed through the light distribution member is acquired, phase information of the interference fringe is calculated by using the acquired luminance information, and a light distribution state of the light distribution member at an observation position is output as phase information by using the calculated phase information.

As illustrated in FIG. 1, when a light distribution member such as a lenticular lens Ls or a parallax barrier Br is provided on the display unit in which pixels are arranged, directivities are imparted to light beams emitted from the pixels by a lens of the lenticular lens Ls or an opening of the parallax barrier Br.

By using the directivities, it is possible to display different images on the left and right eyes of the viewer in a separated manner. Therefore, if images corresponding to the left and right eyes are displayed, the viewer can observe the stereoscopic display. That is, the stereoscopic display illustrated in FIG. 1 is configured to present a stereoscopic object by directly providing different images to the left and right eyes of the viewer via the light distribution member. A stereoscopic display that provides a stereoscopic object without using such a wearable optical device dedicated to stereoscopic vision may be generally referred to as a light field display.

Also, at this time, the light beam direction from each pixel is determined by the positional relationship between the pixel of the display unit and the light distribution member and thus is determined according to various pixel arrays of the display unit illustrated in FIG. 2 and design values of the light distribution member such as a pitch, an inclination angle, and an offset illustrated in FIG. 3 and a thickness illustrated in FIG. 4.

However, the positional relationship between the pixel of the display unit and the light distribution member deviates from the design value due to a manufacturing error such as a molding error of the light distribution member and a deviation at the time of bonding the display unit, an error caused by heat or mechanical stress at the time of use, and the like, and thus the light beam direction is affected by the deviation.

In such a case, as illustrated in FIG. 5, since unevenness occurs in display, it is important to accurately measure the positional relationship during actual use for comfortable stereoscopic display.

A stereoscopic display in which the light distribution member is provided on the display unit illustrated in FIG. 1 is considered. Here, it is assumed that the position of a pixel of the display unit in the x direction is x, the position of the pixel of the display unit in the y direction is y, a display luminance of the display is A, an offset amount of the light distribution member is o, and luminance noise at the time of observation is d.

Then, a luminance distribution I of an interference fringe observed via the light distribution member disposed so that a cosine wave obtained by dividing one cycle of the fringe into N and shifting the phase is displayed with a frequency f_{xd} in the x direction and a frequency f_{yd} in the y direction, and light beams are sampled with a frequency fₓₛ in the x direction and a frequency f_{ys} in the y direction is expressed by Formula (1).

$${I}_{n} ( x , y ) = A ( x , y ) cos [ ( {f}_{xd} - {f}_{xs} ) x - ( {f}_{yd} - {f}_{ys} ) y + o ( x , y ) + \frac{2 π n}{N} ] + d ( x , y ) \qquad ( 1 )$$

In addition, an initial phase θ of the interference fringe is expressed by Formula (2).

$$θ ( x , y ) = ( {f}_{xd} - {f}_{xs} ) x - ( {f}_{yd} - {f}_{ys} ) y \qquad ( 2 )$$

Then, θ can be obtained as in the following Formulas (3) and (4) using a plurality of phase-shifted luminance distributions.

$$tan θ ( x , y ) = - \frac{{\sum }_{n = 0}^{N - 1} {I}_{n} ( x , y ) sin ( \frac{2 π n}{N} )}{{\sum }_{n = 0}^{N - 1} {I}_{n} ( x , y ) cos ( \frac{2 π n}{N} )} \qquad ( 3 )$$

$$θ ( x , y ) = {tan}^{- 1} [ - \frac{{\sum }_{n = 0}^{N - 1} {I}_{n} ( x , y ) sin ( \frac{2 π n}{N} )}{{\sum }_{n = 0}^{N - 1} {I}_{n} ( x , y ) cos ( \frac{2 π n}{N} )} ] \qquad ( 4 )$$

When the measurement is performed with N=3 or more, Formulas (3) and (4) can be solved, and the accuracy of the phase measurement increases as N increases. Then, when the phase information of the light distribution member is obtained by using the obtained θ, Formula (5) is obtained.

$${f}_{xs} x - {f}_{ys} y = - θ ( x , y ) + {f}_{xd} x - {f}_{yd} y \qquad ( 5 )$$

The phase information of Formula (5) indicates the light distribution state of the light beams from each pixel imparted by the light distribution member and means that the viewpoint is repeated at a 2π cycle. Therefore, when 0 to 2π is discretized to a certain number of viewpoints M, light beams from pixels corresponding to spots corresponding to the respective viewpoint positions are spatially distributed.

Therefore, the display corresponding to respective viewpoints can be visually recognized by the viewer by distributing images corresponding to respective viewpoint positions to respective pixels and displaying the images. In FIG. 6, the measured phases are distributed to respective viewpoint as M=256, and FIG. 7 illustrates light beams of which viewpoints are m to m+2 (1≤m≤M−2). Note that, since the viewpoints are distributed in a discrete manner, it is desirable that the intensity peaks of the light beams appear between adjacent viewpoints for the same viewpoint.

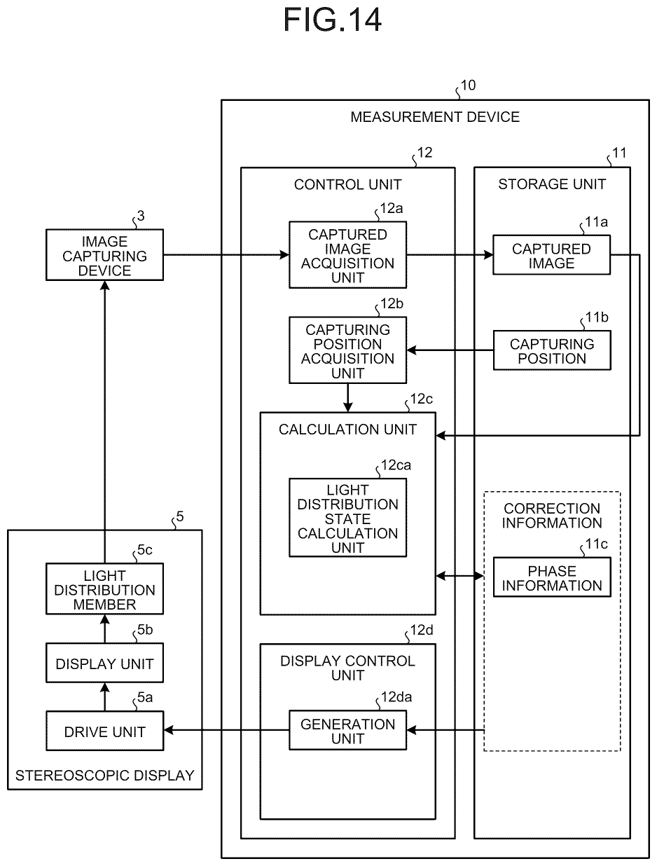

Note that a configuration example of an information processing apparatus using the information processing method according to embodiments including the first embodiment and following second and third embodiments is described below with reference to FIG. 14 and subsequent drawings.

### 2. Information Processing Method According to Second Embodiment

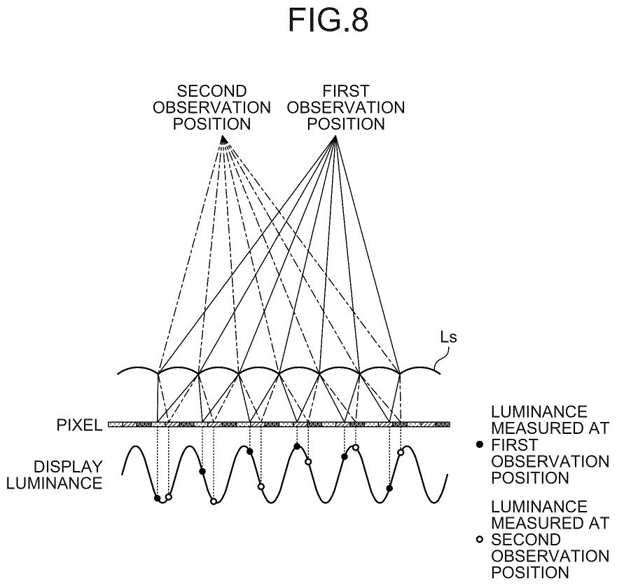

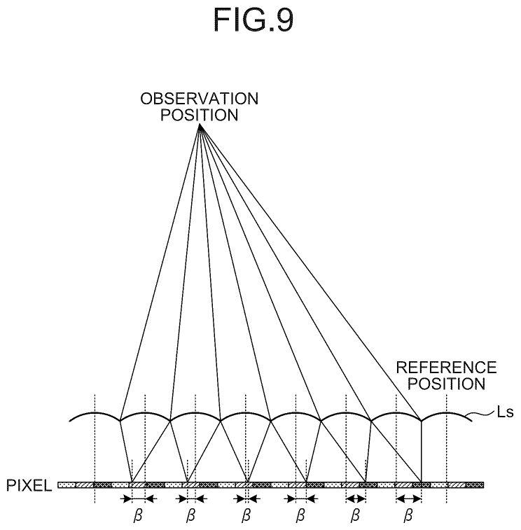

Next, an information processing method according to a second embodiment of the present disclosure is described with reference to FIGS. 8 to 11. FIG. 8 is a diagram illustrating a difference in observation luminance at different observation positions. Also, FIG. 9 is a diagram illustrating a phase shift of the light distribution member from a reference position.

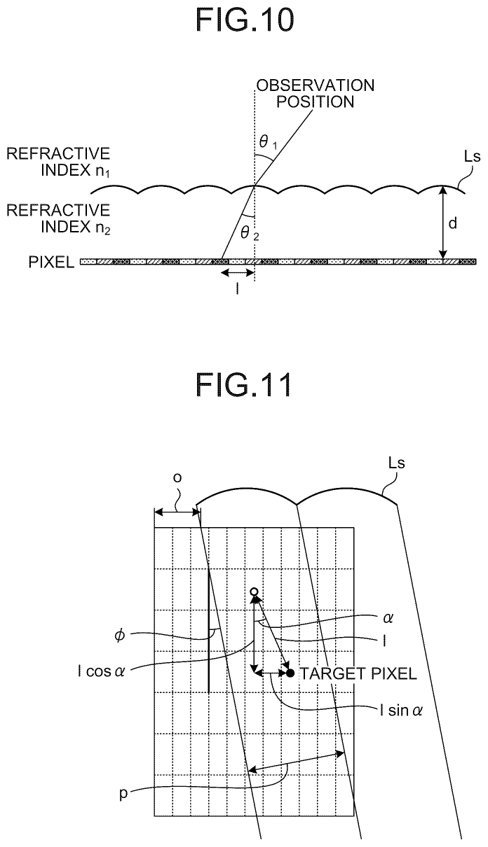

Also, FIG. 10 is a diagram (part 1) illustrating a method of calculating a phase shift amount. Also, FIG. 11 is a diagram (part 2) illustrating the method of calculating the phase shift amount.

The information processing method according to the second embodiment of the present disclosure is a method of measuring an observation position and adjusting a fringe image to be displayed on a display unit while using a phase shift amount corresponding to measured position information, in addition to the information processing method according to the first embodiment.

Specifically, in the first embodiment, since the luminance distribution of the interference fringe corresponding to a specific observation position is measured, the phase information of the light distribution member corresponding to the observation position is calculated. Therefore, as illustrated in FIG. 8, in a case where the observation position moves, different luminance distributions are measured for each observation position, and phase information is also different for each observation position.

Therefore, in a case where the viewpoint position is determined by using the phase information measured at a specific observation position, desired stereoscopic display can be performed only in the vicinity of the observation position. Therefore, in the second embodiment, in order to maintain the accurate stereoscopic display regardless of the observation position, it is considered that the desired stereoscopic display is performed by obtaining the positional relationship between the pixel position of the display unit and the light distribution member as the phase information and adding the adjustment in consideration of the phase shift amount according to the observation position thereto.

Therefore, for example, as illustrated in FIG. 9, when the lenticular lens Ls is used as the light distribution member, and the center of the lens is set as the reference position, a phase shift amount β from the reference position corresponding to the observation position is generated in each pixel. By calculating the phase shift amount β for each pixel and adjusting the luminance distribution of the cosine wave displayed on the display unit, the positional relationship between the pixel and the light distribution member can be obtained as the phase information regardless of the observation position.

It is considered to obtain the phase shift amount in the case where the light distribution member is the lenticular lens Ls with reference to FIGS. 10 and 11. As illustrated in FIG. 10, when an angle at the time of viewing the position of a target pixel for which the phase shift amount is desired to be obtained from the observation position is θ₁, a light beam angle incident on the light distribution member is θ₂, the thickness of the light distribution member is d, a refractive index of a medium on the incident side of the light distribution member is n₁, and a refractive index of the light distribution member is n₂, a difference l in a distance between the position of the target pixel and an actually viewed position can be approximated by Formula (6).

$$I = d tan [ {sin}^{- 1} ( \frac{{n}_{1} sin {θ}_{1}}{{n}_{2}} ) ] \qquad ( 6 )$$

In a case where the light distribution member is formed by staking a plurality of different media, Formula (6) can be applied by converting the refractive index of each layer and the thickness according to the fixed refractive index and adding the thicknesses.

Here, as illustrated in FIG. 11, when 1 is separated into x and y with an angle in the xy plane when the target pixel is viewed from the observation position (see the white circle in the figure) as an expected angle α, a distance difference lₓ in the x direction and a distance difference l_{y} in the y direction are expressed by Formula (7).

$${I}_{x} = I sin α , {I}_{y} = I cos α \qquad ( 7 )$$

Then, by using the distance differences lₓ and l_{y} in Formula (7) and design parameters (inclination angle and pitch p) of the light distribution member, phase differences βₓ and β_{y} caused by the distance differences lₓ and l_{y} are obtained as Formula (8). A measured value may be used as the design parameter.

$${β}_{x} = \frac{{I}_{x} cos ϕ}{p} , {β}_{y} = \frac{{I}_{y} sin ϕ}{p} \qquad ( 8 )$$

Addition or subtraction of the phase shift amount β obtained here is determined depending on the disposition state of the light distribution member. As illustrated in FIG. 11, in the case that the light distribution member is disposed at the inclination angle Φ, and the phase is calculated as 0 to 2π from the left to the right in the front view in one cycle of the light distribution member in the x direction, βₓ is subtracted when the difference is generated in the left direction from the target pixel with respect to the phase of the cosine wave to be displayed, and is added when the difference is generated in the right direction.

Meanwhile, β_{y} is added when a difference is generated in the upward direction from the target pixel and is subtracted when a difference is generated in the downward direction from the target pixel. By adjusting Formula (1) as described above and performing measurement and calculation of phase information similarly to the information processing method according to the first embodiment, it is possible to obtain phase information of the light distribution member regardless of the observation position.

### 3. Information Processing Method According to Third Embodiment

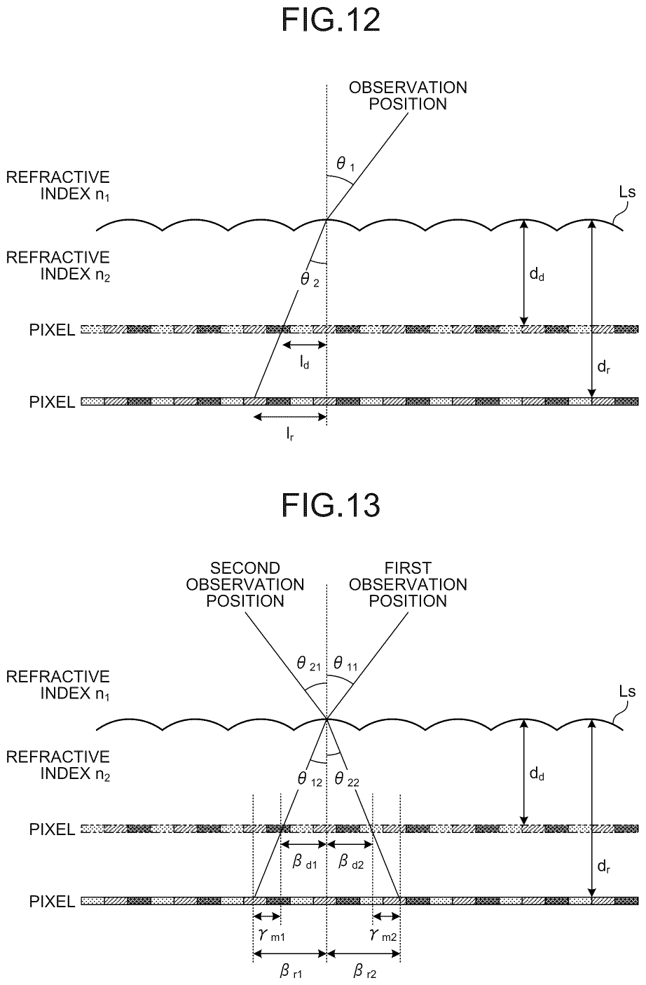

Next, an information processing method according to a third embodiment of the present disclosure is described with reference to FIG. 12 and FIG. 13. FIG. 12 is a diagram illustrating a difference in a phase difference due to a thickness error. Also, FIG. 13 is a diagram illustrating a phase difference caused by a thickness error.

The information processing method according to the third embodiment of the present disclosure is a method of measuring a thickness of a light distribution member by using interference fringes or phase information of the light distribution member acquired from two or more different observation positions, in addition to the information processing method according to the second embodiment.

For example, as illustrated in FIG. 12, in a case where a deviation occurs with respect to a thickness design value d_{d} of the light distribution member, and thus an actual thickness dᵣ is obtained, an assumed difference l_{d} actually becomes a difference lᵣ, and thus, an error occurs in the calculation of the phase shift amount when the observation position changes.

Therefore, in the third embodiment, it is considered that the thickness distribution of the light distribution member is obtained, and the accurate phase shift amount is calculated by using the value. The actual thickness (that is, the measured value of the thickness) of the light distribution member can be obtained by calculating phase information at two different points and comparing the phase difference with the difference between the calculated values of the phase shift amounts.

As illustrated in FIG. 13, when the thickness design value of the light distribution member is d_{d}, the phase shift amounts assumed at a first observation position and a second observation position are β_{d1} and β_{d2}. However, when the phase is measured, since the phase information of the pixel observed with the actual thickness dᵣ is measured, measurement is performed in a state where γₘ₁ and γₘ₂ are added to the phase information as a result at each observation position.

Therefore, when the phase difference between the measurement values at two different points is taken, Y=γₘ₁+γₘ₂ is calculated. This is considered to be equal to the difference between the phase shift amounts β_{d1} and β_{d2} calculated as the thickness design value d_{d} and the phase shift amounts βᵣ₁ and βᵣ₂ at the actual thickness dᵣ.

Therefore, when the expected angles from the first observation position and the second observation position are α₁ and α₂ in the disposition state of the light distribution member similar to FIGS. 10 and 11, the actual thickness dᵣ can be expressed by Formula (9) using Formulas (6) to (8).

$${d}_{r} = {d}_{\text{?}} - \frac{{r}_{p}}{\begin{matrix}( tan {θ}_{12} sin {α}_{3} cos ϕ - tan {θ}_{12} cos {α}_{3} sin ϕ ) - \\ ( tan {θ}_{22} sin {α}_{2} cos ϕ - tan {θ}_{22} cos {α}_{2} sin ϕ )\end{matrix}} \qquad ( 9 )$$

$$\text{?} \text{indicates text missing or illegible when filed}$$

In the two items on the right side of Formula (9), the two items in the parentheses of the denominator are determined as either addition or subtraction depending on the direction of the inclination angle Φ of the light distribution member, and the subtraction is performed in the same example as in FIG. 11.

The phase shift amount is calculated by using the measurement result, and the phase measurement is performed again, or the measured phase information is corrected, so that the phase information from which the thickness error is removed can be obtained, and the phase shift amount can be adjusted without error when the observation position changes.

### 4. Information Processing Apparatus Using Information Processing Method According to Embodiments

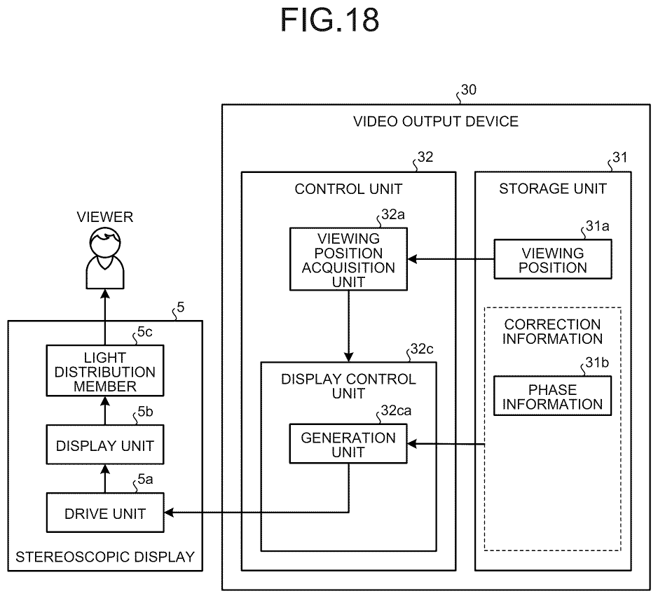

Next, a configuration example of an information processing apparatus using the information processing methods according to the above-described embodiments is described with reference to FIGS. 14 to 20. Measurement devices 10, 10A, and 10B are be described with reference to FIGS. 14 to 17. Video output devices 30, 30A, and 30B are described with reference to FIGS. 18 to 20. The measurement devices 10, 10A, and 10B and the video output devices 30, 30A, and 30B each correspond to an example of an “information processing apparatus”.

### 4-1. Configuration of Measurement Device According to First Embodiment

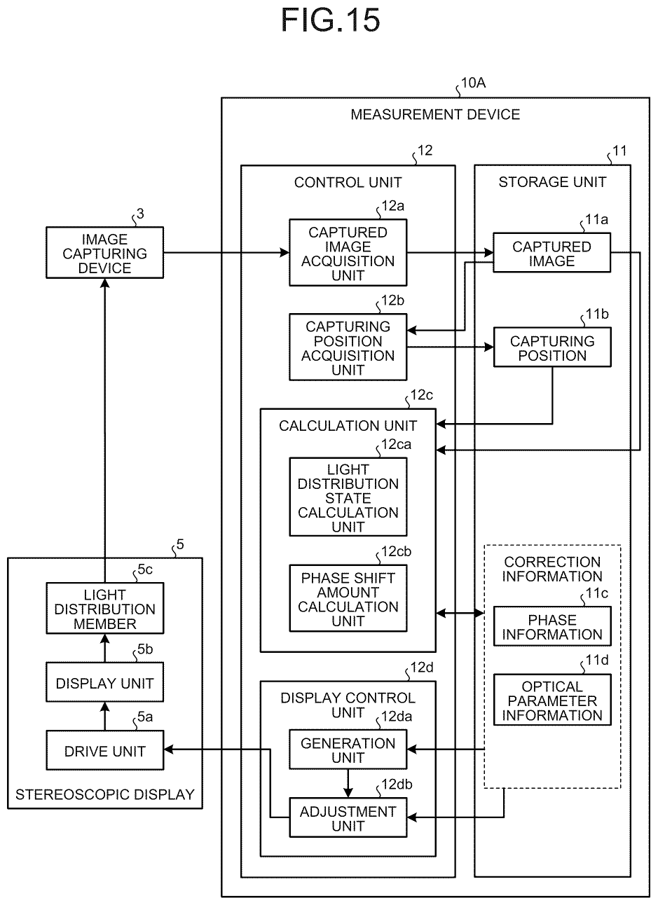

FIG. 14 is a block diagram illustrating a configuration example of the measurement device 10 according to the first embodiment of the present disclosure. Note that, in FIG. 14 and FIGS. 15, 16, and 18 to 20 illustrated below, only components required for describing features of the present embodiment are illustrated, and descriptions of general components are omitted.

In other words, components illustrated in FIGS. 14 to 16 and 18 to 20 are functionally conceptual and are not necessarily physically configured as illustrated in the drawings. For example, a specific form of distribution and integration of each block is not limited to the illustrated form, and all or a part thereof can be configured to be functionally or physically distributed and integrated in an arbitrary unit according to various loads, usage statuses, and the like.

In the description using FIGS. 14 to 16 and 18 to 20, the description of the already described components may be simplified or omitted.

The measurement device 10 is a device that generates a fringe image in a display control unit based on phase information calculated by a calculation unit, inputs the fringe image to a drive unit of a stereoscopic display, receives, to the calculation unit, an input of a captured image obtained by observing the fringe image displayed on the display unit as an interference fringe by an image capturing device via the light distribution member and storing the observed interference fringe image as the captured image in a storage unit, and calculates the phase information of the interference fringe and the light distribution member.

Specifically, as illustrated in FIG. 14, the measurement device 10 includes a storage unit 11 and a control unit 12. In addition, an image capturing device 3 and a stereoscopic display 5 are connected to the measurement device 10. The stereoscopic display 5 includes a drive unit 5a, a display unit 5b, and a light distribution member 5c.

The image capturing device 3 captures a fringe image displayed on the display unit 5b via the light distribution member 5c. The image capturing device 3 can be realized by, for example, a monocular camera, and the observation position in this case corresponds to a midpoint position of the both eyes.

The storage unit 11 is realized by, for example, a semiconductor memory element such as a random access memory (RAM), a read only memory (ROM), or a flash memory or a storage device such as a hard disk or an optical disk. In the example illustrated in FIG. 14, the storage unit 11 stores a captured image 11a, a capturing position 11b, and phase information 11c.

The captured image 11a is an image captured by the image capturing device 3. The capturing position 11b is a position where the captured image 11a is captured. In the first embodiment, the capturing position 11b is a specific position.

The phase information 11c is information indicating the light distribution states of the light beams from each pixel which are imparted by the light distribution member 5c and calculated by a calculation unit 12c described below. The phase information 11c is included in correction information for correcting the display unevenness of the stereoscopic display 5.

The control unit 12 is a controller and is realized by, for example, a central processing unit (CPU), a micro processing unit (MPU), or the like executing various programs stored in the storage unit 11 using the RAM as a work area. Also, the control unit 12 can be realized by, for example, an integrated circuit such as an application specific integrated circuit (ASIC) or a field programmable gate array (FPGA).

The control unit 12 includes a captured image acquisition unit 12a, a capturing position acquisition unit 12b, the calculation unit 12c, and a display control unit 12d and realizes or executes a function and an action of information processing described below.

The captured image acquisition unit 12a acquires an image captured by the image capturing device 3 and stores the acquired image as the captured image 11a. The capturing position acquisition unit 12b acquires the capturing position 11b.

The calculation unit 12c includes a light distribution state calculation unit 12ca. The light distribution state calculation unit 12ca calculates the light distribution state of each pixel observed at the capturing position 11b based on the captured image 11a. Note that the light distribution state calculation unit 12ca calculates the light distribution state by using the calculation method in the information processing method according to the first embodiment described above. In addition, the light distribution state calculation unit 12ca outputs the calculated light distribution state and stores the light distribution state in the storage unit 11 as the phase information 11c.

The display control unit 12d generates and outputs a display control signal for the stereoscopic display 5. The display control unit 12d includes a generation unit 12da. The generation unit 12da generates a fringe image while changing the pattern of the fringe, that is, the phase pattern based on the phase information 11c and outputs a display control signal for displaying the fringe image to the drive unit 5a.

A series of movements by the captured image acquisition unit 12a, the capturing position acquisition unit 12b, the calculation unit 12c, and the display control unit 12d is repeatedly executed, and the phase information 11c can be updated at any time according to the result.

### 4-2. Configuration of Measurement Device According to Second Embodiment

Next, FIG. 15 is a block diagram illustrating a configuration example of the measurement device 10A according to the second embodiment of the present disclosure. Since FIG. 15 corresponds to FIG. 14, only differences from the measurement device 10 illustrated in FIG. 14 are described here.

In addition to the measurement device 10, the measurement device 10A is a device that measures a capturing position (observation position), stores the position in the storage unit 11, inputs the capturing position 11b to the calculation unit 12c, inputs the calculated phase shift amount to the display control unit 12d, and adjusts the fringe image.

Specifically, as illustrated in FIG. 15, the measurement device 10A is different from the measurement device 10 in that the capturing position acquisition unit 12b calculates and acquires the capturing position 11b based on the captured image 11a.

The measurement device 10A is different from the measurement device 10 in that the storage unit 11 further stores optical parameter information 11d. The optical parameter information 11d is information including the inclination angle, the pitch, and the thickness of the light distribution member 5c and is included in the correction information described above.

In addition, the measurement device 10A is different from the measurement device 10 in that the calculation unit 12c further includes a phase shift amount calculation unit 12cb. Based on capturing position 11b and the optical parameter information 11d, the phase shift amount calculation unit 12cb calculates the phase shift amount by using the calculation method in the information processing method according to the second embodiment described above. The calculated phase shift amount is included in, for example, the phase information 11c and stored.

Also, the measurement device 10A is different from the measurement device 10 in that the display control unit 12d further includes an adjustment unit 12db. The adjustment unit 12db adjusts the fringe image generated by the generation unit 12da based on the phase shift amount calculated by the phase shift amount calculation unit 12cb.

### 4-3. Configuration of Measurement Device According to Third Embodiment

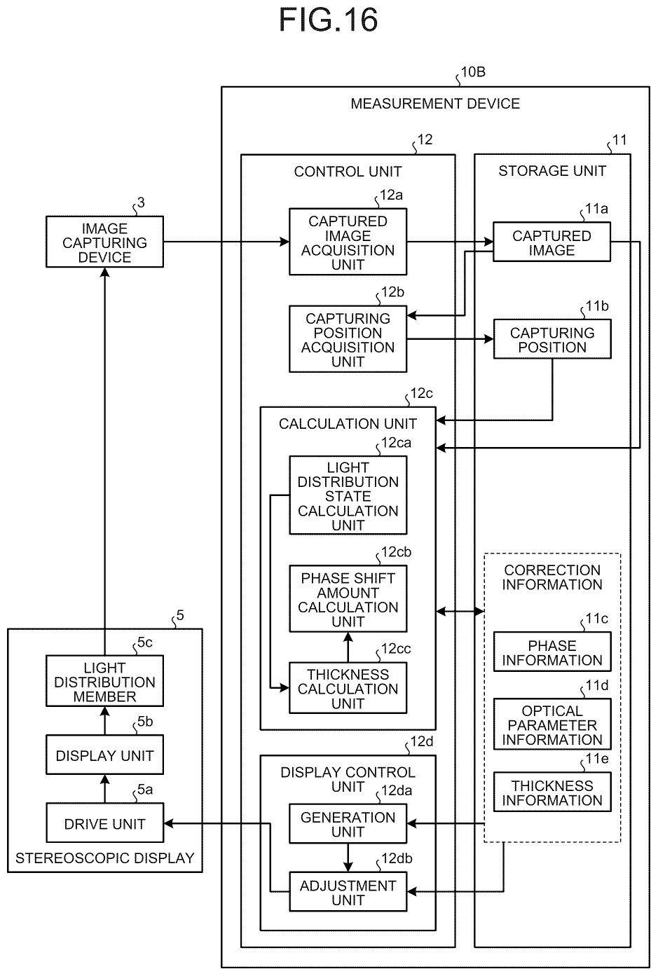

Next, FIG. 16 is a block diagram illustrating a configuration example of the measurement device 10B according to the third embodiment of the present disclosure. Since FIG. 16 corresponds to FIG. 15, only differences from the measurement device 10A illustrated in FIG. 15 are described here.

In addition to the measurement device 10A, the measurement device 10B is a device that stores measurement position information at two or more different observation positions and calculation results of the phase information of the interference fringes or the light distribution member 5c, in the storage unit 11, inputs the results to the calculation unit 12c, and calculates the thickness of the light distribution member 5c.

Specifically, as illustrated in FIG. 16, the measurement device 10B is different from the measurement device 10A in that the storage unit 11 further stores thickness information 11e. The thickness information 11e is information including the actual thickness distribution (that is, the distribution of the measured values of the thickness) of the light distribution member 5c and is included in the correction information described above.

In addition, the measurement device 10B is different from the measurement device 10A in that the calculation unit 12c further includes a thickness calculation unit 12cc. The thickness calculation unit 12cc calculates the thickness distribution by using the calculation method in the information processing method according to the third embodiment described above based on the calculation results of the light distribution state calculation unit 12ca at two or more different capturing positions 11b. The calculated thickness distribution is included in the thickness information 11e and stored.

In addition, the measurement device 10B is different from the measurement device 10A in that the phase shift amount is calculated by using the thickness distribution calculated by the thickness calculation unit 12cc, and the adjustment unit 12db adjusts the fringe image in consideration of the thickness information 11e.

### 4-4. Supplement for Measurement Device According to Embodiments

Note that, in the measurement devices 10, 10A, and 10B, respective functions may be separated from or integrated with the respective devices, a part or all of the functions of the measurement devices 10, 10A, and 10B may be incorporated into the stereoscopic display 5, or a part or all of the functions of the measurement devices 10, 10A, and 10B may be incorporated into the image capturing device 3.

In addition, the measurement devices 10, 10A, and 10B can correct the optical parameter information 11d and the phase information 11c based on the measured phase information 11c. For example, the inclination angle and the pitch of the light distribution member 5c can be calculated by using the phase difference between adjacent pixels of the phase information of the light distribution member 5c.

When the measured value and the design value are deviated from each other, the phase information 11c of the light distribution member 5c can be corrected by a method of correcting the value according to the measured value, calculating the phase shift amount again by using the corrected optical parameter value, and correcting the phase information 11c of the light distribution member 5c already acquired by using the value, or the phase information 11c of the light distribution member 5c can be corrected by measuring the interference fringe obtained by adjusting the fringe image by using the measured optical parameter value again. That is, the optical parameter information 11d includes a measured value for the design value.

Also, in a case where the thickness distribution is acquired by the measurement, similarly, the phase information 11c of the light distribution member 5c can be corrected by using the thickness distribution. In the phase measurement, the distortion of the interference fringe image to be measured can be suppressed by feeding back the calculation result of the phase information 11c to the generation of the fringe image, and the accuracy of the phase calculation using the image can be improved. Therefore, the accuracy of the calculated phase information 11c can be improved by repeating the phase information measurement of the light distribution member 5c a plurality of times.

Furthermore, in the measurement devices 10A and 10B, in order to calculate the capturing position 11b, it is considered to estimate the position of the image capturing device 3 by displaying a calibration pattern such as a chessboard on the display unit 5b.

At this time, in a case where the position of the image capturing device 3 can be fixed and measured, if the observation position using the chessboard is calculated before the measurement of the interference fringes, and the fringe image is adjusted using the information, it is not required to update the position information for each measurement, and thus, it is possible to speed up the measurement.

Meanwhile, in a case where calibration is performed by an end user holding the image capturing device 3 by hand, it is considered that the position of the image capturing device 3 moves for each capturing. Therefore, it is required to acquire position information at the same time as capturing of the interference fringes.

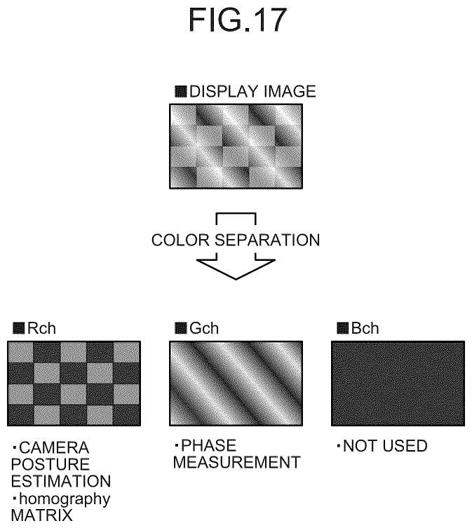

FIG. 17 is a supplementary explanatory view of the measurement devices 10, 10A, and 10B according to each embodiment. In such a case, as illustrated in FIG. 17, for example, the calibration pattern and the fringe image may be displayed in different display colors on the display unit 5b, the display image may be acquired, color separation may be performed by signal processing, and the position measurement and the phase measurement of the interference fringe may be performed from each pattern. However, at this time, since the observation position at the time of capturing is unknown, adjustment of the fringe image according to the observation position cannot be performed.

Therefore, in such a case, it is possible to obtain the phase information 11c of the light distribution member 5c regardless of the observation position by acquiring the phase information in which the fringe image is not adjusted and then adjusting the phase information by the phase shift amount estimated from the observation position.

### 4-5. Configuration of Video Output Device According to First Embodiment

Next, FIG. 18 is a block diagram illustrating a configuration example of the video output device 30 according to the first embodiment of the present disclosure.

The video output device 30 is a device that controls display of the stereoscopic display 5 so as to correct the display unevenness of the stereoscopic display 5, for example, based on the correction information output from the measurement device 10 by using the information processing method according to the first embodiment described above. Note that the video output device 30 may be configured integrally with the stereoscopic display 5.

Specifically, as illustrated in FIG. 18, the video output device 30 includes a storage unit 31 and a control unit 32. Further, the video output device 30 is connected to the stereoscopic display 5.

Similarly to the storage unit 11, the storage unit 31 is realized by, for example, a semiconductor memory element such as a RAM, a ROM, or a flash memory, or a storage device such as a hard disk or an optical disk. In the example illustrated in FIG. 18, the storage unit 31 stores a viewing position 31a and phase information 31b.

The viewing position 31a corresponds to an observation position of the display image by the viewer. In the first embodiment, the viewing position 31a is a specific position.

The phase information 31b is, for example, information corresponding to the phase information 11c included in the correction information calculated and output by the measurement device 10.

Similarly to the storage unit 11 described above, the control unit 32 is a controller and is realized by, for example, a CPU, an MPU, or the like executing various programs stored in the storage unit 31 using the RAM as a work area. Furthermore, the control unit 32 can be realized, for example, by an integrated circuit such as an ASIC or an FPGA.

The control unit 32 includes a viewing position acquisition unit 32a and a display control unit 32c and realizes or executes a function and an action of information processing described below.

The viewing position acquisition unit 32a acquires the viewing position 31a. The display control unit 32c generates and outputs a display control signal for the stereoscopic display 5. The display control unit 32c includes a generation unit 32ca. The generation unit 32ca generates a display image while correcting the display unevenness based on the phase information 31b, and outputs a display control signal for displaying the display image to the drive unit 5a.

### 4-6. Configuration of Video Output Device According to Second Embodiment

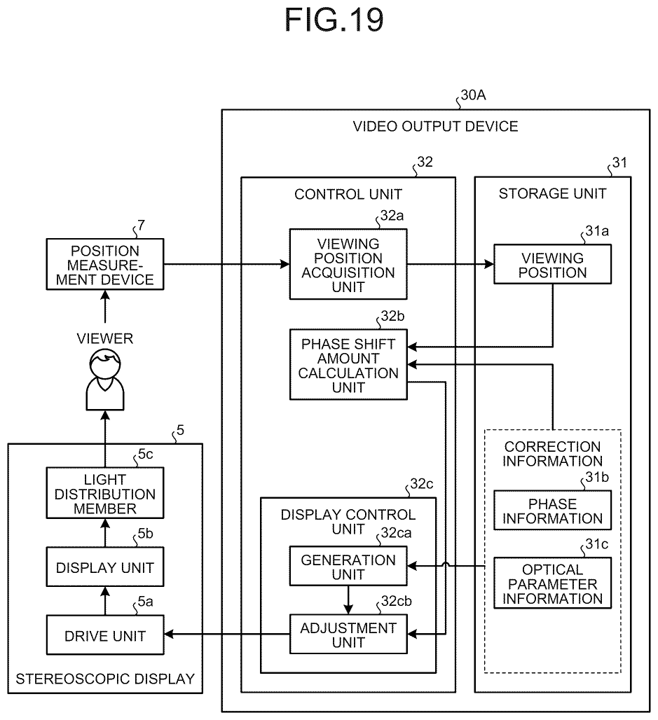

Next, FIG. 19 is a block diagram illustrating a configuration example of the video output device 30A according to the second embodiment of the present disclosure. Since FIG. 19 corresponds to FIG. 18, only differences from the video output device 30 illustrated in FIG. 18 are described here.

In addition to the video output device 30, the video output device 30A is a device that measures a viewing position (observation position), stores the position in the storage unit 31, calculates a phase shift amount based on the viewing position 31a, inputs the calculated phase shift amount to the display control unit 12d, and adjusts the display image.

Specifically, as illustrated in FIG. 19, the video output device 30A is different from the video output device 30 in that a position measurement device 7 is further connected. The position measurement device 7 measures a viewing position of viewing. Note that, as a position measurement method, a method of estimating the viewing position by detecting a face of the viewer from the captured image, a method of detecting the position by three-dimensional measurement, and the like can be considered.

Furthermore, the video output device 30A is different from the video output device 30 in that the viewing position acquisition unit 32a acquires the viewing position 31a from the position measurement device 7.

Further, the video output device 30A is different from the video output device 30 in that the storage unit 31 further stores optical parameter information 31c. The optical parameter information 31c corresponds to the optical parameter information 11d included in the correction information output from the measurement device 10A.

Further, the video output device 30A is different from the video output device 30 in that the control unit 32 further includes a phase shift amount calculation unit 32b. Based on the viewing position 31a and the optical parameter information 31c, the phase shift amount calculation unit 32b calculates the phase shift amount by using the calculation method in the information processing method according to the second embodiment described above.

Furthermore, the video output device 30A is different from the video output device 30 in that the display control unit 32c further includes an adjustment unit 32cb. The adjustment unit 32cb adjusts the display image generated by the generation unit 32ca based on the phase shift amount calculated by the phase shift amount calculation unit 32b.

### 4-7. Configuration of Video Output Device According to Third Embodiment

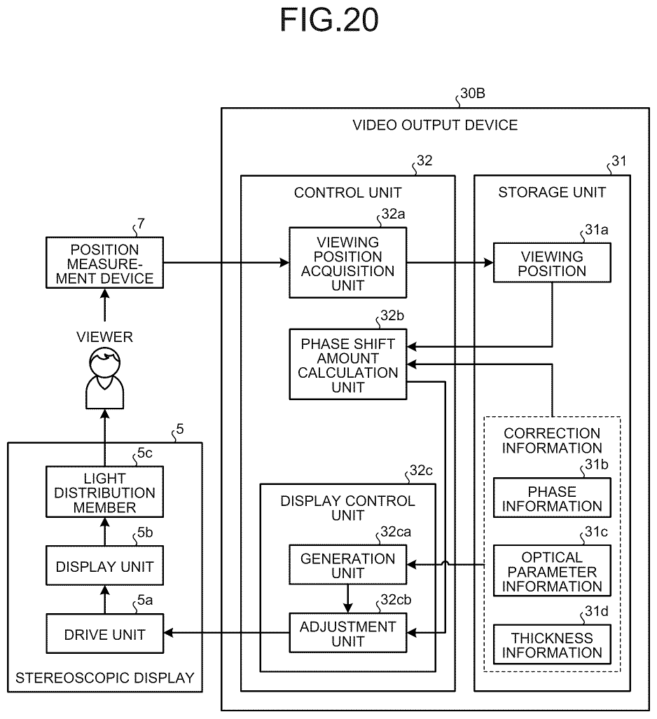

FIG. 20 is a block diagram illustrating a configuration example of the video output device 30B according to the third embodiment of the present disclosure. Since FIG. 20 corresponds to FIG. 19, only differences from the video output device 30A illustrated in FIG. 19 are described here.

As illustrated in FIG. 20, the video output device 30B is different from the video output device 30A in that the storage unit 31 further stores thickness information 31d. The thickness information 31d corresponds to the thickness information 11e included in the correction information output from the measurement device 10B.

Further, the video output device 30B is different from the video output device 30A in that the phase shift amount calculation unit 32b calculates the phase shift amount by further using the thickness information 31d and the adjustment unit 32cb adjusts the display image based on the phase shift amount.

### 4-8. Correction Information Output Unit

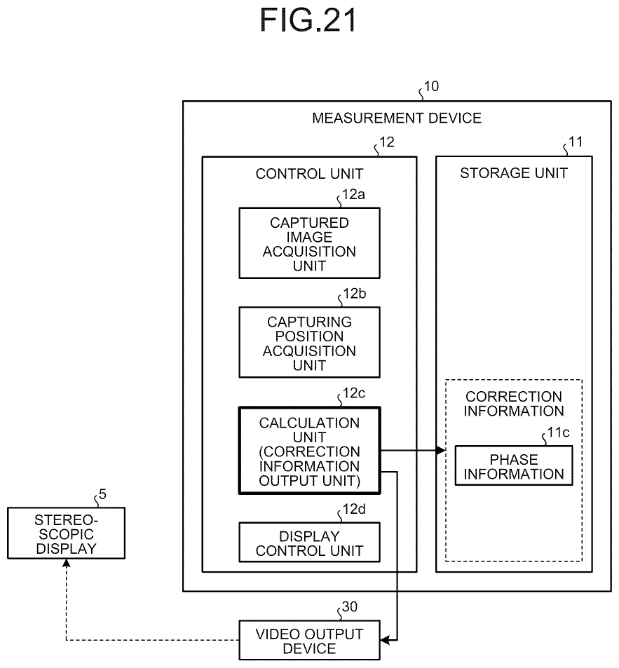

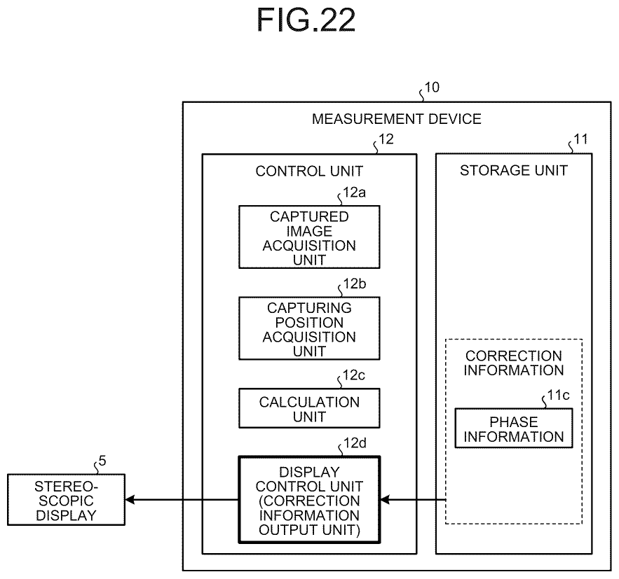

Note that the “calculation unit” and the “display control unit” of the information processing apparatus according to each embodiment described above can be rephrased as a “correction information output unit” that outputs correction information for correcting display unevenness. This point is described with reference to FIGS. 21 and 22 while taking the above-described measurement device 10 as an example.

FIG. 21 is an explanatory diagram (part 1) of the correction information output unit. Also, FIG. 22 is an explanatory diagram (part 2) of the correction information output unit.

As illustrated in FIG. 21, the measurement device 10 includes a calculation unit 12c, and the calculation unit 12c can be referred to as a “correction information output unit” that outputs correction information for the stereoscopic display 5 including the calculated phase information 11c and the like.

For example, the measurement device 10 outputs the correction information for the stereoscopic display 5 to the storage unit 11. Furthermore, for example, the measurement device 10 outputs the correction information for the stereoscopic display 5 to the video output device 30. Note that the output form to the video output device 30 may be transmission via a network or transfer via a recording medium. Alternatively, the correction information may be distributed via a cloud server or the like.

Meanwhile, as illustrated in FIG. 22, the measurement device 10 includes the display control unit 12d, and the display control unit 12d can be referred to as a “correction information output unit” that outputs the correction information for the stereoscopic display 5 including the phase information 11c and the like as the display control signal.

Although FIGS. 21 and 22 illustrate the measurement device 10 as an example, the same applies to the measurement devices 10A and 10B and the like.

Therefore, the correction information output from the “correction information output unit” also includes, for example, the optical parameter information 11d and the thickness information 11e described above.

### 5. Modifications

Note that each of the above-described embodiments can include some modifications. For example, in each of the above-described embodiments, the case where the light distribution member 5c is the lenticular lens Ls is mainly described but the light distribution member 5c is not limited thereto.

The light distribution member 5c may be, of course, the parallax barrier Br illustrated in FIG. 1 or another member.

Among the processes described in the above-described embodiments, all or a part of the processes described as being performed automatically can be performed manually, or all or a part of the processes described as being performed manually can be performed automatically by a known method. In addition, the processing procedure, specific names, and information including various data and parameters disclosed in the document and the drawings can be arbitrarily changed unless otherwise specified. For example, the various types of information illustrated in each figure are not limited to the illustrated information.

In addition, each component of each device illustrated in the drawings is functionally conceptual and is not necessarily physically configured as illustrated in the drawings. That is, a specific form of distribution and integration of each device is not limited to the illustrated form, and all or a part thereof can be configured to be functionally or physically distributed and integrated in an arbitrary unit according to various loads, usage statuses, and the like. As described above, for example, the video output device 30 may be configured integrally with the stereoscopic display 5.

In addition, each embodiment can be appropriately combined in a region in which the processing contents do not contradict each other.

### 6. Hardware Configuration

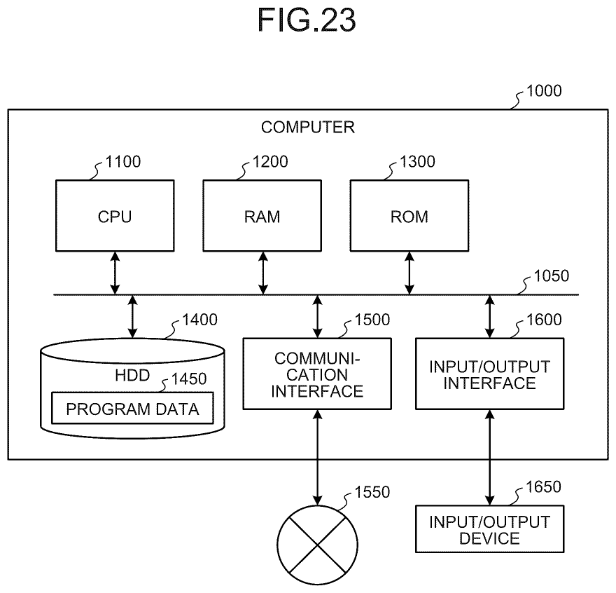

The measurement devices 10, 10A, and 10B and the video output devices 30, 30A, and 30B according to the above-described embodiments are realized by a computer 1000 having a configuration as illustrated in FIG. 23, for example. The measurement device 10 is described as an example. FIG. 23 is a hardware configuration diagram illustrating an example of the computer 1000 that realizes functions of the measurement device 10. The computer 1000 includes a CPU 1100, a RAM 1200, a ROM 1300, a hard disk drive (HDD) 1400, a communication interface 1500, and an input/output interface 1600. Each unit of the computer 1000 is connected by a bus 1050.

The CPU 1100 operates based on a program stored in the ROM 1300 or the HDD 1400 and controls each unit. For example, the CPU 1100 loads the program stored in the ROM 1300 or the HDD 1400 into the RAM 1200 and executes processing corresponding to various programs.

The ROM 1300 stores a boot program such as a basic input output system (BIOS) executed by the CPU 1100 at the time of activating the computer 1000, a program depending on hardware of the computer 1000, and the like.

The HDD 1400 is a computer-readable recording medium that records a program executed by the CPU 1100, data used by the program, and the like in a non-transitory manner. Specifically, the HDD 1400 is a recording medium that records an information processing program according to the present disclosure which is an example of program data 1450.

The communication interface 1500 is an interface for the computer 1000 to connect to an external network 1550 (for example, the Internet). For example, the CPU 1100 receives data from another device or transmits data generated by the CPU 1100 to another device via the communication interface 1500.

The input/output interface 1600 is an interface for connecting an input/output device 1650 and the computer 1000. For example, the CPU 1100 receives data from an input device such as a keyboard and a mouse via the input/output interface 1600. In addition, the CPU 1100 transmits data to an output device such as a display, a speaker, or a printer via the input/output interface 1600. Furthermore, the input/output interface 1600 may function as a media interface that reads a program or the like recorded in a predetermined recording medium (media). The medium is, for example, an optical recording medium such as a digital versatile disc (DVD) or a phase change rewritable disk (PD), a magneto-optical recording medium such as a magneto-optical disk (MO), a tape medium, a magnetic recording medium, or a semiconductor memory.

For example, when the computer 1000 functions as the measurement device 10 according to the embodiment, the CPU 1100 of the computer 1000 realizes the functions of the control unit 12 by executing the information processing program loaded onto the RAM 1200. In addition, the HDD 1400 stores the information processing program according to the present disclosure and data in the storage unit 11. Note that the CPU 1100 reads the program data 1450 from the HDD 1400 and executes the program data, but as another example, these programs may be acquired from another device via the external network 1550.

### 7. Conclusion

As described above, according to an embodiment of the present disclosure, the measurement devices 10, 10A, and 10B include: the captured image acquisition unit 12a that acquires the captured image of the stereoscopic display 5 including the light distribution member 5c disposed on the display unit 5b that distributes the light beams of the image displayed on the display unit 5b to allow the stereoscopic object to be visually recognized; the capturing position acquisition unit 12b that acquires the capturing position at the time of acquisition of the captured image; and the calculation unit 12c or the display control unit 12d (corresponding to an example of a “correction information output unit”) that outputs correction information for the stereoscopic display 5 for correcting display unevenness of the stereoscopic display 5 based on the change in the phase pattern which is included in the captured image and generated according to the capturing position, and the capturing position. This can contribute to resolution of image quality degradation in stereoscopic display.

Although each embodiment of the present disclosure has been described above, the technical scope of the present disclosure is not limited to the embodiments described above as it is, and various modifications can be made without departing from the gist of the present disclosure. In addition, components of different embodiments and modifications may be appropriately combined.

Furthermore, the effects of each embodiment described in the present specification are merely examples and are not limited, and other effects may be provided.

Note that the present technology can also have the following configurations.

(1)

An information processing apparatus comprising:
a captured image acquisition unit that acquires a captured image of a stereoscopic display including a light distribution member disposed on a display unit that distributes a light beam of an image displayed on the display unit to allow a stereoscopic object to be visually recognized;
a capturing position acquisition unit that acquires a capturing position at the time of acquisition of the captured image; and
a correction information output unit that outputs correction information for the stereoscopic display for correcting display unevenness of the stereoscopic display based on a change in a phase pattern which is included in the captured image and generated according to the capturing position, and the capturing position.
   (2)

The information processing apparatus according to (1),
wherein the correction information is a display control signal for controlling display of the stereoscopic display so as to correct display unevenness of the stereoscopic display.
   (3)

The information processing apparatus according to (2),
wherein the correction information output unit
generates the display control signal based on phase information indicating a light distribution state of a light beam from each pixel of the display unit imparted by the light distribution member based on a change in the phase pattern.
   (4)

The information processing apparatus according to (3),
wherein the correction information output unit
generates the display control signal based on the phase information when the phase pattern is changed by displaying a fringe image on the display unit while shifting a phase.
   (5)

The information processing apparatus according to (4),
wherein the correction information output unit
generates the display control signal based on the phase information when a cosine wave obtained by dividing one cycle of a fringe by three or more and shifting the phase is displayed on the display unit.
   (6)

The information processing apparatus according to (3),
wherein the phase information includes a positional relationship between a pixel position of the display unit and the light distribution member, and
the correction information output unit
generates the display control signal based on a phase shift amount from a predetermined reference position of the light distribution member corresponding to the capturing position, the phase shift amount being calculated based on the phase information.
   (7)

The information processing apparatus according to (6),
wherein the correction information output unit
generates the display control signal based on the phase shift amount based on a measured value of a thickness of the light distribution member calculated based on comparison of the phase information of each of the different capturing positions.
   (8)

The information processing apparatus according to (1),
wherein the correction information includes a measured value with respect to a design value related to disposition of the light distribution member.
   (9)

The information processing apparatus according to (8),
wherein the measured value includes a measured value of a thickness of the light distribution member with respect to the display unit.
   (10)

The information processing apparatus according to (9),
wherein the correction information output unit
calculates phase information including a light distribution state of a light beam from each pixel of the display unit imparted by the light distribution member based on the change in the phase pattern and calculates the measured value of the thickness based on the phase information.
   (11)

The information processing apparatus according to (10),
wherein the correction information output unit
calculates a luminance distribution of an interference fringe in a case where a fringe image is displayed on the display unit while shifting a phase, included in the captured image and calculates the phase information based on the luminance distribution.
   (12)

The information processing apparatus according to (10) or (11),
wherein the correction information output unit
calculates a measured value of the thickness based on comparison of the phase information of each of the different capturing positions.
   (13)

The information processing apparatus according to (10), (11) or (12),
wherein the phase information includes a positional relationship between a pixel position of the display unit and the light distribution member, and
the correction information output unit
calculates a phase shift amount from a predetermined reference position of the light distribution member corresponding to the capturing position based on the phase information and adjusts the phase shift amount based on the measured value of the thickness.
   (14)

The information processing apparatus according to any one of (1) to (13),
wherein the light distribution member is a lenticular lens or a parallax barrier.
   (15)

The information processing apparatus according to (14),
wherein the stereoscopic display is configured to present the stereoscopic object by directly providing different images to left and right eyes of a viewer via the light distribution member.
   (16)

An information processing method comprising:
acquiring a captured image of a stereoscopic display including a light distribution member disposed on a display unit that distributes a light beam of an image displayed on the display unit to allow a stereoscopic object to be visually recognized;
acquiring a capturing position at the time of acquisition of the captured image; and
outputting correction information for the stereoscopic display for correcting display unevenness of the stereoscopic display based on a change in a phase pattern which is included in the captured image and generated according to the capturing position, and the capturing position.
   (17)

A computer-readable recording medium that stores a program for causing a computer to realize:
acquiring a captured image of a stereoscopic display including a light distribution member disposed on a display unit that distributes a light beam of an image displayed on the display unit to allow a stereoscopic object to be visually recognized;
acquiring a capturing position at the time of acquisition of the captured image; and
outputting correction information for the stereoscopic display for correcting display unevenness of the stereoscopic display based on a change in a phase pattern which is included in the captured image and generated according to the capturing position, and the capturing position.

### REFERENCE SIGNS LIST

3 IMAGE CAPTURING DEVICE
5 STEREOSCOPIC DISPLAY
5a DRIVE UNIT
5b DISPLAY UNIT
5c LIGHT DISTRIBUTION MEMBER
10, 10A, 10B MEASUREMENT DEVICE
12a CAPTURED IMAGE ACQUISITION UNIT
12b CAPTURING POSITION ACQUISITION UNIT
12c CALCULATION UNIT
12d DISPLAY CONTROL UNIT
30, 30A, 30B VIDEO OUTPUT DEVICE
31a VIEWING POSITION
31b PHASE INFORMATION
31c OPTICAL PARAMETER INFORMATION
31d THICKNESS INFORMATION
32a VIEWING POSITION ACQUISITION UNIT
32b PHASE SHIFT AMOUNT CALCULATION UNIT
32c DISPLAY CONTROL UNIT
Br PARALLAX BARRIER
Ls LENTICULAR LENS

1. An information processing apparatus comprising:
a captured image acquisition unit that acquires a captured image of a stereoscopic display including a light distribution member disposed on a display unit that distributes a light beam of an image displayed on the display unit to allow a stereoscopic object to be visually recognized;
a capturing position acquisition unit that acquires a capturing position at the time of acquisition of the captured image; and
a correction information output unit that outputs correction information for the stereoscopic display for correcting display unevenness of the stereoscopic display based on a change in a phase pattern which is included in the captured image and generated according to the capturing position, and the capturing position.

2. The information processing apparatus according to claim 1,
wherein the correction information is a display control signal for controlling display of the stereoscopic display so as to correct display unevenness of the stereoscopic display.

3. The information processing apparatus according to claim 2,
wherein the correction information output unit
generates the display control signal based on phase information indicating a light distribution state of a light beam from each pixel of the display unit imparted by the light distribution member based on a change in the phase pattern.

4. The information processing apparatus according to claim 3,
wherein the correction information output unit
generates the display control signal based on the phase information when the phase pattern is changed by displaying a fringe image on the display unit while shifting a phase.

5. The information processing apparatus according to claim 4,
wherein the correction information output unit
generates the display control signal based on the phase information when a cosine wave obtained by dividing one cycle of a fringe by three or more and shifting the phase is displayed on the display unit.

6. The information processing apparatus according to claim 3,
wherein the phase information includes a positional relationship between a pixel position of the display unit and the light distribution member, and
the correction information output unit
generates the display control signal based on a phase shift amount from a predetermined reference position of the light distribution member corresponding to the capturing position, the phase shift amount being calculated based on the phase information.

7. The information processing apparatus according to claim 6,
wherein the correction information output unit
generates the display control signal based on the phase shift amount based on a measured value of a thickness of the light distribution member calculated based on comparison of the phase information of each of the different capturing positions.

8. The information processing apparatus according to claim 1,
wherein the correction information includes a measured value with respect to a design value related to disposition of the light distribution member.

9. The information processing apparatus according to claim 8,
wherein the measured value includes a measured value of a thickness of the light distribution member with respect to the display unit.

10. The information processing apparatus according to claim 9,
wherein the correction information output unit
calculates phase information including a light distribution state of a light beam from each pixel of the display unit imparted by the light distribution member based on the change in the phase pattern and calculates the measured value of the thickness based on the phase information.

11. The information processing apparatus according to claim 10,
wherein the correction information output unit
calculates a luminance distribution of an interference fringe in a case where a fringe image is displayed on the display unit while shifting a phase, included in the captured image and calculates the phase information based on the luminance distribution.

12. The information processing apparatus according to claim 10,
wherein the correction information output unit
calculates a measured value of the thickness based on comparison of the phase information of each of the different capturing positions.

13. The information processing apparatus according to claim 10,
wherein the phase information includes a positional relationship between a pixel position of the display unit and the light distribution member, and
the correction information output unit
calculates a phase shift amount from a predetermined reference position of the light distribution member corresponding to the capturing position based on the phase information and adjusts the phase shift amount based on the measured value of the thickness.

14. The information processing apparatus according to claim 1,
wherein the light distribution member is a lenticular lens or a parallax barrier.

15. The information processing apparatus according to claim 14,
wherein the stereoscopic display is configured to present the stereoscopic object by directly providing different images to left and right eyes of a viewer via the light distribution member.

16. An information processing method comprising:
acquiring a captured image of a stereoscopic display including a light distribution member disposed on a display unit that distributes a light beam of an image displayed on the display unit to allow a stereoscopic object to be visually recognized;
acquiring a capturing position at the time of acquisition of the captured image; and
outputting correction information for the stereoscopic display for correcting display unevenness of the stereoscopic display based on a change in a phase pattern which is included in the captured image and generated according to the capturing position, and the capturing position.
